(19) United States
(12) Patent Application Publication
(10) Pub. No.: US 2016/0034729 A1
(43) Pub. Date: Feb. 4, 2016

(54) RFID INTEGRATED ANTENNA SYSTEM

(71) Applicant: Promega Corporation, Madison, WI (US)

(72) Inventors: Mark Sehmer, Stoughton, WI (US); Travis Phillips, Stoughton, WI (US); Brian George, Brodhead, WI (US)

(21) Appl. No.: 14/445,612

(22) Filed: Jul. 29, 2014

(51) Int. Cl. G06K 7/10

(52) U.S. Cl. CPC G06K 7/10356; G06K 7/10297

(57) ABSTRACT

An RFID system includes at least one host controller and at least one antenna module coupled to the host controller. The antenna module may include a plurality of antenna elements, at least one multiplexer (MUX) module integrated in the antenna module, and an RFID reader integrated in the antenna module. The outputs of the MUX module may be coupled to the plurality of antenna elements, respectively, for selecting at least one active antenna element at a given time from among the plurality of antenna elements during a scanning operation. The RFID reader may be coupled to an input of the MUX module, and may be operable to conduct, based on control information received from the host controller, RFID scans via the plurality of antenna elements.

### CROSS-REFERENCE TO RELATED APPLICATIONS

(Not Applicable)

### FIELD OF THE DISCLOSURE

In general, the present disclosure relates to radio-frequency identification (RFID) communication systems. More specifically, certain embodiments of the disclosure relate to one or more methods and systems for an RFID integrated antenna system.

### BACKGROUND OF THE DISCLOSURE

Existing methods and systems for RFID communications may be costly, cumbersome and ineffective. Further limitations and disadvantages of conventional and traditional approaches will become apparent to one of skill in the art, through comparison of such systems with the present disclosure as set forth in the remainder of the present application with reference to the drawings.

### BRIEF SUMMARY OF THE DISCLOSURE

At least some embodiments of the present technology depicted herein relate to an antenna module configured to be coupled to a host controller. The antenna module may include a plurality of antenna elements. At least one multiplexer (MUX) module may be integrated in the antenna module. The outputs of the MUX module may be coupled to the plurality of antenna elements, respectively, for selecting at least one active antenna element among a plurality of antenna elements as desired during operation of the present technology based upon a variety of factors including, but not limited to, time, operation, operative command(s) and demand, among others. At least one radio-frequency identification (RFID) reader may be integrated in the antenna module. The RFID reader may be coupled to an input of the MUX module. The RFID reader may be operable to conduct, based on control information received from the host controller, RFID scans via the plurality of antenna elements.

In some embodiments of the present technology, the plurality of antenna elements are arranged in an array, such as a 3×2 array, a 2×2 array, or a 2×1 array. In some embodiments, the antenna module may be coupled to the host controller via a single communication cable. The communication cable may provide low-voltage electrical power to the antenna module as well as provide communications between the antenna module and the host controller. In further embodiments, the antenna module may be operable to communicate with the host controller utilizing an Ethernet communication. In some embodiments, the antenna module may be operable to communicate with the host controller utilizing a UART. In still further embodiments, the antenna module may be operable to communicate with the host controller utilizing a host controller area network (CAN) bus and low level reader protocol (LLRP) commands.

In some embodiments, the MUX module may include a MUX element or a plurality of MUX elements arranged in a chain.

Certain embodiments of the present technology relate to an RFID system that includes at least one host controller and at least one antenna module coupled to the host controller. The antenna module may include a plurality of antenna elements, at least one multiplexer (MUX) module integrated in the antenna module, and a reader integrated in the antenna module. The output of the MUX module may be coupled to the plurality of antenna elements, respectively, for selecting at least one active antenna element among the plurality of antenna elements as desired during operation of the present technology based upon a variety of factors including, but not limited to, time, operation, operative command(s) and demand, among others. The RFID reader may be coupled to an input of the MUX module and may be may be operable to conduct based on control information received from the host controller, RFID scans via the plurality of antenna elements.

In certain embodiments, the host controller may be operable to perform one or more of the following: coordinating activities of the antenna module, concatenating resulting data collected by the RFID reader, control access to the unit, record data from a sensor(s), and communicating the data to an attached and/or remote device for processing. The remote device can be, for example, at least one enterprise resource planning (ERP) system, a website, a server, and/or a personal computer, among others. The host controller may communicate with the remote device via a communication network, such as a network cable, cellular modem, or wireless modem, for example.

The host controller may be configured to control selection of each of the plurality of antenna elements in the array in a programmable fashion. For example, the host controller may communicate with the reader module to trigger the reader module to select specific antenna elements using GPIO signals.

In some embodiments, at least one additional antenna module may be coupled to the host controller. In such embodiments, the host controller may be operable to communicate with and control operation of the additional antenna module(s) in the manner discussed above. In some embodiments, multiple antenna modules may be located inside a single enclosure. In other embodiments, each antenna module may be installed in a respective enclosure.

Various advantages, aspects and novel features of the present disclosure, as well as details of an illustrated embodiment thereof, will be more fully understood from the following description and drawings.

### BRIEF DESCRIPTION OF SEVERAL VIEWS OF THE DRAWINGS

FIG. 1 is a block diagram illustrating an example communication system, in accordance with an embodiment of the disclosure.

FIG. 2 is a block diagram illustrating an example top view of an antenna module, in accordance with an embodiment of the disclosure.

FIG. 3 is a block diagram illustrating an example side view of an antenna module, in accordance with an embodiment of the disclosure.

### DETAILED DESCRIPTION OF THE DISCLOSURE

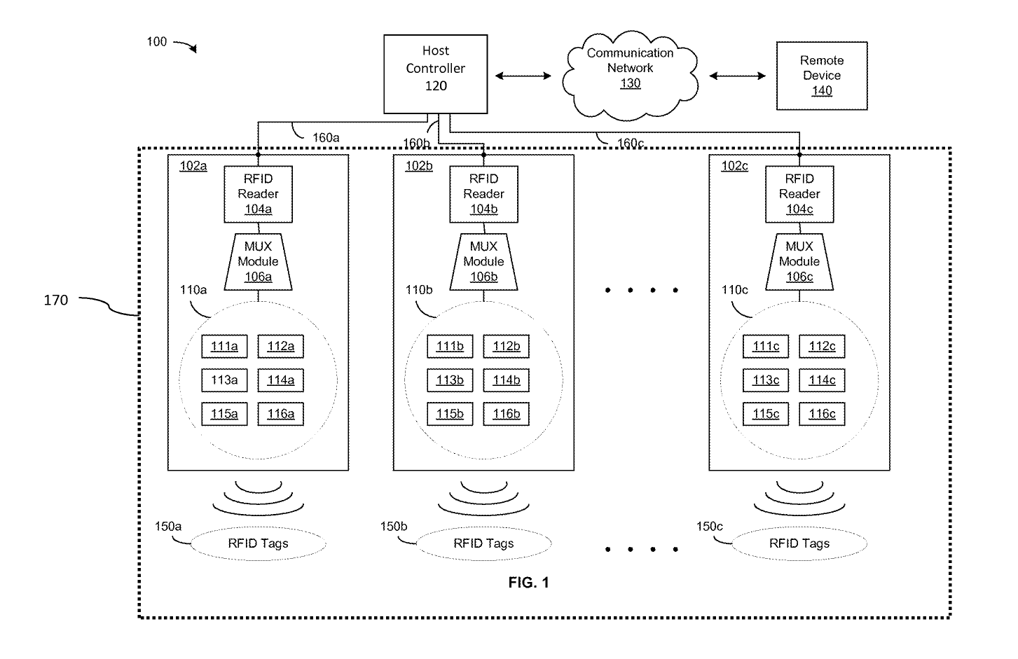

FIG. 1 is a block diagram illustrating an exemplar communication system, in accordance with at least one embodiment of the present technology. Referring to FIG. 1, there is shown a communication system 100. The communication system 100 may include at least one host controller 120, at least one communication network 130, at least one remote device 140, a plurality of antenna modules 102a-102c, and a plurality of radio-frequency identification (RFID) tags 150a-150c.

In some embodiments of the present technology, each of the plurality of antenna modules 102a-102c may include a plurality of antenna elements with an integrated RFID reader and an integrated multiplexer (MUX) module. For example, the antenna module 102a may include at least one integrated RFID reader 104a, at least one MUX module 106a, and a plurality of antenna elements 110a of which antenna elements 111a-116a are illustrated. The antenna module 102b may include at least one integrated RFID reader 104b, at least one MUX module 106b, and a plurality of antenna elements 110b of which antenna elements 111b-116b are illustrated. The antenna module 102c may include at least one integrated RFID reader 104c, at least one MUX module 106c, and a plurality of antenna elements 110c of which antenna elements 111c-116c are illustrated. In an exemplary embodiment of the present technology, the antenna elements (e.g., the antenna elements 111a-116a) in each of the plurality of antenna modules 102a-102c (e.g., the antenna module 102a) may be arranged in an array to provide RF coverage for certain area associated with the corresponding RFID tags (e.g., the RFID tags 150a).

The integrated RFID reader, such as the RFID reader 104a, may include suitable logic, circuitry, interfaces, and/or code known to those skilled in the relevant art that may be operable to conduct RFID scans, via the plurality of antenna elements 110a, of the plurality of corresponding RFID tags 150a, and collect scan data concerning products or items to which the RFID tags 150a are attached. An RFID reader that is suitable for use in at least some embodiments is an INDY® RS500 RFID reader as is available from Impinj, Inc. In some embodiments, the RFID reader 104a may be operable to activate one of the antenna elements at a time 110a such that the one or more antenna elements 110a emit at least one signal at a predefined frequency and generate an electromagnetic field sufficient to permeate the area associated with the RFID tags 150a. The RFID reader 104a may conduct the RFID scans based on control information received from the host controller 120.

The integrated MUX module, such as the MUX module 106a, may include suitable logic, circuitry, interfaces, and/or code known to those skilled in the relevant art that may be operable to allow usage of the plurality of antenna elements 110a. Outputs of the MUX module 106a may be coupled to the plurality of antenna elements 110a, respectively, for selecting one active antenna element at a given time among from the plurality of antenna elements 110a during an operation of the system of the present technology. An input of the MUX module 106a may be coupled to the RFID reader 104a. In an exemplary embodiment of the present technology, the MUX module 106a may include at least one MUX element. In another exemplary embodiment, the MUX module 106a may include a plurality of MUX elements arranged in a chain to achieve the overall multiplexing function.

The host controller 120 may include suitable logic, circuitry, interfaces, and/or code known to those skilled in the relevant art that may be operable to control and/or manage operations of the plurality of antenna modules 102a-102c. The host controller 120 may be coupled to and communicate with each of the plurality of antenna modules 102a-102c, such as the antenna module 102a, via a single communication cable such as a communication cable 160a. Using a single cable for this connection facilitates integration with the system and allows for easy expansion as needed. In this regard, the communication cable 160a may provide low-voltage electrical power to the antenna module 102a as well as communication(s) between the antenna module 102a and the host controller 120. For example, the host controller 120 may be operable to communicate with the antenna module 102a, utilizing LLPR commands over the communication cable 160a.

In another exemplary embodiment of the present technology, the host controller 120 may be operable to perform one or more of the following for each of the plurality of antenna modules 102a-102c, such as the antenna module 102a: coordinating activities of the antenna module 102a, concatenating resulting tag data collected by the RFID reader 104a from the RFID tags 150a, and communicating the tag data to the remote device 140 for processing. In this regard, the host controller 120 may be operable to communicate with the antenna module 102a employing at least one host controller area network (CAN) bus and low level reader protocol (LLRP) commands, for example. The host controller 120 may be operable to communicate with the remote device 140 via, for example, the communication network 130.

The communication network 130 may include suitable logic, circuitry, interfaces, devices, and/or code known to those skilled in the relevant art that may be operable to provide data communication services to various electrical devices such as the host controller 120 and the remote device 140 by using wireless and/or wired communication technologies. In this regard, the communication network 130 may be an Internet network, a telephone network, a wireless network, a power line carrier (PLC) network, or other type of network, or system as well as combinations thereof. In an exemplary embodiment of the present technology, the communication network 130 may be operable to provide wireless communications between the host controller 120 and the remote device 140 utilizing cellular, Wi-Fi, and/or Bluetooth communications. Alternatively or additionally, the communication network 130 may also be operable to provide wired communications between the host controller 120 and the remote device 140 utilizing, for example, Ethernet communication.

The remote device 140 may include suitable logic, circuitry, interfaces and/or code known to those skilled in the relevant art that may be operable to process data or information received from the host controller 120. The remote device 140 may include, for example, an enterprise resource planning (ERP) system, a website, a server, a personal computer (PC), and/or other similar computing device. In some embodiments, the remote device 140 may include multiple servers and databases, for example. In a further exemplary embodiment of the present technology, the remote device 140 may be operable to process the scan data, communicated from a RFID reader such as the RFID reader 104a via the host controller 120, to generate and update appropriate records (e.g., inventory, restocking, invoicing, temperature, alarms, system status, etc.).

In operation, the communication system 100 may be operable to collect data or information regarding products, samples, or other items associated with the RFID tags 150a-150c, using the plurality of antenna modules 102a-102c, and transmit, over the communication network 130, that data or information to the remote device 140 for processing. In this regard, for example, the products, samples, or other items may be located on shelves in a storage environment. To non-exhaustively illustrate, for example, the products, samples, or items may include pharmaceuticals, biologics, medical devices, such as implants and/or related medical instruments, e.g., surgical instruments, among others.

The host controller 120 may be operable to couple to the plurality of antenna modules 102a-102c. Each of the plurality of antenna modules 102a-102c, such as the antenna module 102a, may include a plurality of antenna elements 110a and at least one integrated RFID reader 104a and at least one integrated MUX module 106a. The host controller 120 may be configured to systematically control selection of each of the plurality of antenna elements, such as each of the antenna elements 110a, in the antenna module 102a in a programmable fashion, for example. For example, the host controller 120 may control factors such as the dwell time on each antenna element, delay between switching and/or the switching order of antenna element activation, among other factors. Each RFID reader module 102a-102c may include a command set (e,g, LLRP) by which it can be controlled. Commands may be sent from the host controller 120 to a given RFID reader, e.g., reader 102a, via a respective communication cable, e.g., 160a, to instruct the RFID reader to, for example, perform an RFID scan via one or more of the antennas and return a list of tags read based on the signals received from an RFID tag or RFID tags.

In an exemplary embodiment of the present technology, the communication system 100 may be scalable. The host controller 120 may be operable to initially couple to one antenna module, such as the antenna module 102a. In instances when more antennas are need for RFID scanning, one or more antenna modules, such as the antenna modules 102b, 102c, may then be added to the communication system 100, for example, as needed.

In a further exemplary embodiment of the present technology, the plurality of antenna modules 102a-102c may be inside an enclosure 170. In this regard, the enclosure 170 may be a cabinet, a freezer, a portable case, or a defined space holding inventory, samples or products, among others. In a still further exemplary embodiment of the disclosure, the plurality of antenna modules 102a-102c may be installed in multiple enclosures. In such instances, the antenna modules 102a-102c installed in the multiple enclosures may be linked as a single logical entity coupled to a single host controller 120

In an additional exemplary embodiment of the present technology, the host controller 120 may also be integrated into one of the plurality of antenna modules 102a-102c such as the antenna module 102a. In such an instance, the antenna module 102a with the integrated host controller may act as a primary (or master) antenna module managing and/or controlling one or more secondary (or slave) antenna modules, such as the antenna modules 102b, 102c.

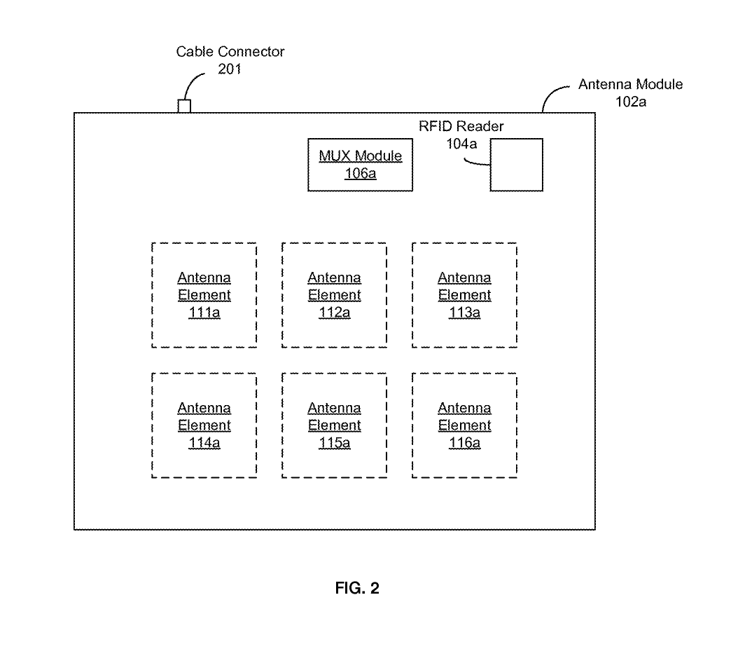

FIG. 2 is a block diagram illustrating an example top view of an antenna module, in accordance with an example embodiment of the present technology. Referring to FIG. 2, there is shown a top view of the antenna module 102a. The antenna module 102a may be as described with respect to FIG. 1, for example. The antenna module 102a may include the plurality of antenna elements 111a-116a, the integrated RFID reader 104a, and the integrated MUX module 106a as described with respect to FIG. 1, for example. There is also shown in FIG. 2 a cable connector 201 at a back of the antenna module 102a. The cable connector 201 may provide an interface for connecting a communication cable, such as the communication cable 160a. In a further exemplary embodiment of the present technology, the cable connector 201 may include a RJ45 jack, a RJ14 jack, a RJ11 jack, a D-sub connector, a barrel jack, or the like. In this regard, the communication cable 160a may provide low-voltage electrical power to the antenna module 102a as well as communications between the antenna module 102a and the host controller 120. Communication links among the RFID reader 104a, the MUX module 106a, and the plurality of antenna elements 111a-116a may be provided and integrated in the antenna module 102a. In such instances, a plurality of external RF coaxial cables (e.g., for communication between the antenna elements 111a-116a and the RFID reader 104) and a power cord for the RFID reader 104a may be eliminated. The antenna module may be provided as an integrated unit where the various components, i.e., RFID reader 104a, MUX module 106a, antenna elements 111a-116a, and cable connector are integrated together, e.g., on a chip or board. This configuration will significantly reduce the cost of the communication system 100. It also allows for a more simplified system that is easier and less costly to repair. Further, this construction makes the system customizable and scalable as desired. In particular, the system can be expanded by simply connecting additional antenna modules to the host controller 120.

In the exemplary embodiment, six antenna elements 111a-116a are shown in the antenna module 102a. Notwithstanding, the disclosure is not so limited and a different number of antenna elements (e.g., more than six or less than six) may be provided without departing from the spirit and scope of various embodiments of the present technology.

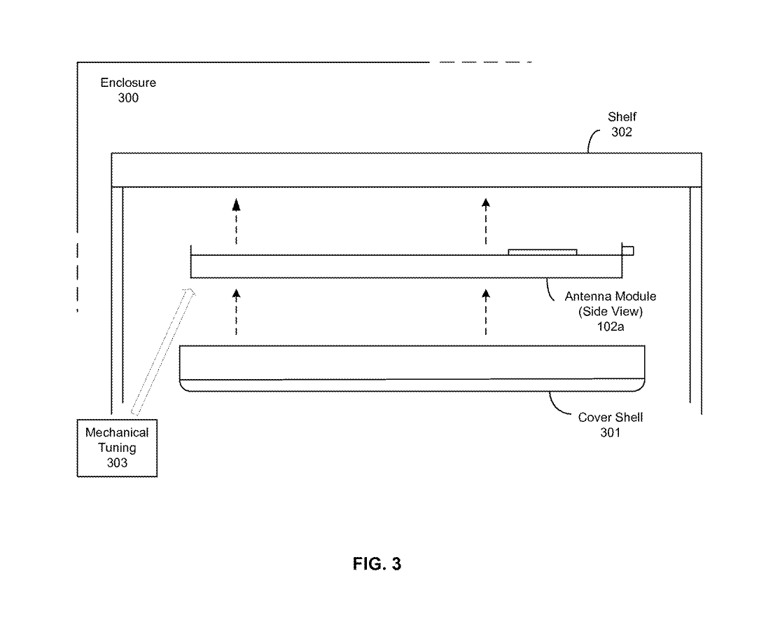

FIG. 3 is a block diagram illustrating an example side view of an antenna module, in accordance with at least one example embodiment of the present technology. Referring to FIG. 3, there is shown a side view of the antenna module 102a inside an enclosure 300. The antenna module 102a may be as described with respect to FIG. 1 and FIG. 2, for example. There is also shown in FIG. 3 a shelf 302 inside the enclosure 300 and a cover shell 301 for the antenna module 102a.

In at least one exemplary embodiment of the present technology, the enclosure 300 may be a cabinet, a freezer, or a defined space which holds inventory, samples or products, among others. The antenna module 102a may be affixed or mounted inside the enclosure 300 in a variety of orientations. This will build-in enough flexibility to be compatible with a variety of enclosure types. The cover shell 301 may be used to protect the integrated antenna components. The cover shell 301 may also provide a stable mechanical mount to a shelf, such as the shelf 302. For example, the antenna module 102a may be sealed inside the cover shell 301, which may in turn be mounted to the shelf 302.

In a further exemplary embodiment of the disclosure, the antenna module 102a may include a provision for mechanical tuning, e.g., by subtly adjusting the overall thickness of the radiating element, in order to optimize performance of the antenna module 102a in various enclosure environments. For example, the geometry of the enclosure 300 may impact the antenna module 102a differently, and employing a method to compensate for this may reduce the need for different antenna designs for a different enclosure model. As another example, the enclosure 300 may include an ultra-low temperature (ULT) environment such as a freezer with −80° C. In such instances, the tuning may take place after the antenna module 102a has stabilized at a desired operating temperature because the constituent materials may be affected by the operating temperature differently.

In a still further exemplary embodiment of the present technology, adjacent antenna elements in the antenna module 102a may become part of the mechanical tuning process for an active antenna element in the antenna module 102a as a form of constructive interference to aid in forming an ideal RF beam(s). For example, in other embodiments of the present technology, each antenna element such as the antenna element 111a in the antenna module 102a may include specific materials. For example, the antenna element 111a may include a printed circuit board (PCB) construction laminated together with foam or other temperature stable materials. The antenna design may account for mechanical material changes (e.g., via the mechanical tuning 303) that may occur in different operating environments (e.g., at a ULT environment) so that the antenna element 111a may remain in-tune once installed and at the operating temperature. For example, the antenna element 111a may be used at ambient temperatures by subtly adjusting the foam spacing via the mechanical tuning 303.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

What is claimed is:

1. An antenna module configured to be coupled to a host controller, comprising:
a plurality of antenna elements integrated in the antenna module;
a multiplexer (MUX) module integrated in the antenna module, wherein outputs of the MUX module are coupled to the plurality of antenna elements, respectively, for selecting at least one active antenna element at a given time from among the plurality of antenna elements during an operation; and
a radio-frequency identification (RFID) reader integrated in the antenna module, wherein the RFID reader is coupled to an input of the MUX module, and is operable to conduct, based on control information received from the host controller, RFID scans via the plurality of antenna elements.

2. The antenna module according to claim 1, wherein the plurality of antenna elements are arranged in an array.

3. The antenna module according to claim 1, wherein the MUX module comprises one MUX element or a plurality of MUX elements arranged in a fan-out configuration where a first MUX element feeds a plurality of other MUX elements.

4. The antenna module according to claim 1, wherein the antenna module is operable to communicate with the host controller utilizing at least one of a UART, Ethernet communication, a host controller area network (CAN) bus and low level reader protocol (LLRP) commands.

5. The antenna module according to claim 1, wherein the antenna module is coupled to the host controller via a single communication cable.

6. The antenna module according to claim 5, wherein the communication cable provides low-voltage electrical power to the antenna module as well as communications between the antenna module and the host controller.

7. A radio-frequency identification (RFID) system, comprising:
at least one host controller; and
at least one antenna module coupled to the host controller, the antenna module comprising:
a plurality of antenna elements;
at least one multiplexer (MUX) module integrated in the antenna module, wherein outputs of the MUX module are coupled to the plurality of antenna elements, respectively, for selecting at least one active antenna element at a given time from among the plurality of antenna elements during an operation; and
a RFID reader integrated in the antenna module, wherein the RFID reader is coupled to an input of the MUX module, and is operable to conduct, based on control information received from the host controller, RFID scans via the plurality of antenna elements.

8. The system according to claim 7, wherein the plurality of antenna elements are arranged in an array.

9. The antenna module according to claim 7, wherein the MUX module comprises one MUX element or a plurality of MUX elements arranged in a fan-out configuration where a first MUX element feeds a plurality of other MUX elements.

10. The antenna module according to claim 7, wherein the antenna module is operable to communicate with the host controller utilizing at least one of a UART, Ethernet communication, a host controller area network (CAN) bus and low level reader protocol (LLRP) commands.

11. The antenna module according to claim 7, wherein the antenna module is coupled to the host controller via a single communication cable.

12. The antenna module according to claim 11, wherein the communication cable provides low-voltage electrical power to the antenna module as well as communications between the antenna module and the host controller.

13. The system according to claim 7 wherein the host controller is operable to perform one or more of the following: coordinating activities of the antenna module, concatenating resulting data collected by the RFID reader, and communicating the data to at least one remote device for processing.

14. The system according to claim 13, wherein the remote device comprises an at least one enterprise resource planning (ERP) system, a website, a server, and/or a personal computer.

15. The system according to claim 13, wherein the host controller communicates with the remote device via at least one communication network.

16. The system according to claim 7, wherein the host controller is configured to control selection of each of the plurality of antenna elements in a programmable fashion.

17. The system according to claim 7, further comprising at least one additional antenna module, and wherein the host controller is operable to communicate with the at least one additional antenna module.

18. The system according to claim 17, wherein the antenna module and the one or more other antenna modules are inside a single enclosure.

19. The system according to claim 17, wherein each the antenna module and the at least one additional antenna module are each installed in separate enclosures.
